(19) United States
(12) Patent Application Publication
(10) Pub. No.: US 2008/0240720 A1
(43) Pub. Date: Oct. 2, 2008

(54) Terminal device, center device, optical communication network system and upstream signal timing control method

(75) Inventor: Akihiro Fujii, Tokyo (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/010,532

(22) Filed: Jan. 25, 2008

(30) Foreign Application Priority Data
Mar. 26, 2007 (JP) JP-2007-079827

(51) Int. Cl. H04J 14/08; H04B 10/00

(52) U.S. Cl. 398/102; 398/154

(57) ABSTRACT

An upstream signal timing control method which controls a timing of an upstream optical signal, from a terminal device to a center device, to a timing that the center device intends. Optical clock pulses synchronized with the timing that the center device intends are sent from the center device to the terminal device. The terminal device delay-controls the optical clock pulses and retransmits them to the center device. The center device detects an offset between the timing and a timing of the returned optical clock pulses, and applies timing offset information to the transmitted optical clock pulses. The terminal device performs the delay control in accordance with the timing offset information applied to the received optical clock pulses. When the offset between the timing and the returned optical clock pulse timing is at or below a threshold, the center device verifies completion of timing control of the upstream optical signal.

### CROSS-REFERENCE TO RELATED APPLICATION

This application claims priority under 35 USC 119 from Japanese Patent Application No. 2007-079827, the disclosure of which is incorporated by reference herein.

### BACKGROUND OF THE INVENTION

1. Field of the Invention

The present invention relates to a terminal device, a center device, an optical communication network system and an upstream signal timing control method. The present invention is applicable to, for example, a bidirectional time division multiplexing optical communication network system, for performing bidirectional communications using time division multiplexing (TDM) between a center (central office) device and a number of terminal devices with a PON (passive optical network). In particular, the present invention is applicable to a time slot control method for establishing synchronization of upstream signals from the terminal devices to the center device, and a structure for implementing the control method.

2. Description of the Related Art

Access networks which provide low cost, high-speed, high-quality communications have emerged with the realization of broadband communications. In particular, subscriber-type optical communication systems with which broadband content can be utilized in subscriber homes at low cost, by using light as a propagation medium, have been attracting attention. These are networks which transmit from a core network to respective subscribers using optical signals instead of conventional electronic signals. Heretofore, optical access systems that use a variety of multiplexing methods have been proposed.

Conventional optical access networks principally use dynamic bandwidth allocation systems.

However, with the progress of IP-integration in recent years, opportunities for transmitting and receiving broadcast-type content over IP networks have been on the increase. As exemplified by P2P, applications have emerged in which an individual host fulfils the roles of server and client. Hence, because traffic volumes between hosts have also been on the increase, it is thought that the importance of fixed bandwidth allocation systems will not change. Moreover, in systems which employ dynamic bandwidth allocation, it is necessary to continually perform complex scheduling. Consequently, the cost of system construction is an issue.

As an example of a bidirectional optical access network, there is a network illustrated in Japanese Patent Application Laid-Open (JP-A) No. 2000-49702. The network illustrated therein includes an office side device (center device), and a number of subscriber side devices which transmit and receive signals to and from the office side device via individual propagation paths among a plurality of propagation paths. A subscriber side device is equipped with propagation path information transmission means which transmits to the office side device configuration information, representing which propagation path is currently being used, and reserve status information, indicating failures in reserve systems. The office side device is equipped with propagation path monitoring means, which receives the configuration information and reserve the status information and monitors statuses of propagation paths. The network structure presented in this example is an optical burst signal multiplexing propagation system which, between the office side device and optical subscriber line terminations, through branches from star couplers via optical subscriber lines, uses TDM for a downstream signal multiplexing system, TDMA (time division multiple access) for an upstream burst signal multiplexing system, and TCM (time compression multiplexing) for a bidirectional propagation system. An example is illustrated in which optical propagation paths have duplex structures. Currently, an optical network which is structured through branches from star couplers between an office side device and optical subscriber line terminations via optical subscriber lines in such a manner is referred to as a PON. In particular, a single-core bidirectional PON can realize FTTH (fiber to the home) at low cost, and accordingly has been researched extensively in recent years.

In JP-A No. 11-298430, a PON which realizes bidirectionality with a TDM system has been proposed. According to this system, an increase in volumes of downstream signals is enabled, without ONUs (optical network units) that structure the system being made faster, simply by providing compatibility with an optical access network system that uses a conventional PON.

In “GE-PON technology, part 3: DBA technology”, in the NTT Technical Journal, October 2005, pp. 67 to 70, a system which uses GE-PON (gigabit Ethernet PON) has been described as an optical access network system based on TDM that has attracted attention in recent years. In such a GE-PON, as downstream signals, OTDM (optical time division multiplexing) signals are transmitted synchronously from an OLT (optical line terminal), and at ONUs, received signals for respective ONUs are identified on the basis of a dedicated header. For upstream optical signals, with a view to efficient use of spare bandwidth, TDMA is utilized, and for preventing collisions of packets transmitted from the ONUs, MPCP (multi point control protocol), provided in a higher level than the physical layer in which the propagation paths are defined, is used for carrying out bandwidth scheduling. Furthermore, when upstream signals from the ONUs are at a maximum, dynamic bandwidth allocation control is performed such that these signals can be accommodated. This dynamic bandwidth allocation is carried out using a DBA (dynamic bandwidth allocation) algorithm provided in an even higher layer than the MPCP.

In JP-A No. 2004-222255, a PON based on WDM, with which establishment of synchronization of time slots is not required, has been proposed. In this system, a different wavelength is allocated to each channel. Therefore, there is no need to establish synchronization for the channels as with the above-mentioned PON based on TDM, and it is possible to set the same bit rates separately for upstream signals and downstream signals. Structure of this system is simpler than a PON based on TDM. Moreover, in an optical access network system based on this WDM-PON, light sources which generate upstream carrier lights are disposed at the OLT. Therefore, there is no need to provide a light source for generating an upstream carrier light at each ONU.

However, in the optical access network system described in JP-A No. 11-298430, which can achieve an increase in capacity of downstream signals, accurate distances from optical splitters/couplers (star couplers) structuring the PON to each ONU must be established beforehand. Specification of parameters and suchlike in advance is necessary in order to perform establishment of synchronizations, in order to enable identification of time slots for respective upstream signals by the OLT.

Furthermore, with the DBA algorithm employed in the technology described in the aforementioned “GE-PON technology, part 3: DBA technology”, extremely complex software control is required. That is, complex packet processing in a high layer is required for establishing synchronization, such as control for collision prevention of the upstream signals transmitted from the ONUs, control for dynamic bandwidth allocation in order to preserve equitability of bandwidth usage, and the like.

Further yet, in the PON based on a WDM system described in JP-A No. 2004-222255, it is necessary to prepare light sources at the OLT in the same number as the ONUs, and numerous wavelength sources are required. In order to guarantee numerous wavelength sources, wavelength control is performed precisely, it is necessary to prepare a plurality of wavelength light sources, and the reality of high costs in practice is an issue.

### SUMMARY OF THE INVENTION

The present invention has been made in view of the above circumstances and provides a terminal device, a center device, an optical communication network system and an upstream signal timing control method.

According to an aspect of the invention, there is provided an upstream signal timing control method which controls a timing of an upstream optical signal, from a terminal device to a center device, to a timing that the center device intends, the upstream signal timing control method comprising: transmitting, from the center device to the terminal device, optical clock pulses synchronized with the timing that the center device intends; the terminal device controlling a delay of the optical clock pulses and returning the optical clock pulses to the center device; the center device detecting an offset between the timing and a timing of the returned optical clock pulses, and including information of the timing offset in the optical clock pulses that are being sent, and the terminal device performing the delay control in accordance with the information of the timing offset that has been included in the optical clock pulses that are received by the terminal device; and the center device verifying completion of timing control of the upstream optical signal, when the offset between the timing and the timing of the returned optical clock pulses is less than a threshold value.

### BRIEF DESCRIPTION OF THE DRAWINGS

Preferred embodiments of the present invention will be described in detail based on the following figures, wherein:

FIG. 1 is a flowchart (1) showing a time slot control method (upstream direction phase synchronization establishment method) in an optical communication network system relating to an embodiment.

FIG. 2 is a flowchart (2) showing the time slot control method (upstream direction phase synchronization establishment method) in the optical communication network system relating to the embodiment.

FIG. 3 is a block diagram showing basic structure of a bidirectional time division multiplexing optical communication network system relating to the embodiment.

FIG. 4 is a block diagram showing detailed structure of an OLT relating to the embodiment.

FIG. 5 is a block diagram showing detailed structure of an ONU relating to the embodiment.

FIG. 6A to FIG. 6C are wavecharts of signals at respective portions of the OLT relating to the embodiment.

FIG. 7 is a block diagram showing internal structure of a phase shift section relating to the embodiment. FIG. 8 is a block diagram showing internal structure of an optical clock pulse generation section relating to the embodiment. FIG. 9 is an explanatory diagram showing an input/output characteristic of an EA modulator employed in the embodiment.

FIG. 10A and FIG. 10B are signal wavecharts showing two signals which are compared at a phase comparison section relating to the embodiment.

FIG. 11 is a block diagram showing internal structure of a timing comparison section relating to the embodiment.

FIG. 12 is an explanatory diagram of a control operation corresponding to a timing offset at the optical clock pulse generation section relating to the embodiment.

FIG. 13(A1) to FIG. 13(A3) and FIG. 13(B1) to FIG. 13(B3) are explanatory views of operations of the timing comparison section relating to the embodiment.

FIG. 14 is a signal wavechart relating to the embodiment showing optical clock pulses when timings match.

FIG. 15 is a signal wavechart relating to the embodiment showing optical clock pulses after the end of a step S12.

FIG. 16A to FIG. 16C are signal wavecharts showing input/output signals of an applicable slot selection section relating to the embodiment.

FIG. 17A is a signal wavechart showing a waveform of an upstream signal from the ONU relating to the embodiment.

FIG. 17B is a signal wavechart showing a waveform of upstream electronic pulse signals from an upstream signal generation section of the ONU relating to the embodiment.

FIG. 18 is a signal wavechart showing signals arriving at an OLT of another embodiment.

### DETAILED DESCRIPTION OF THE INVENTION

Herebelow, an embodiment of a terminal device, a center device, an optical communication network system and an upstream signal timing control method according to the present invention will be described in detail with reference to the drawings.

### Structure of Embodiment

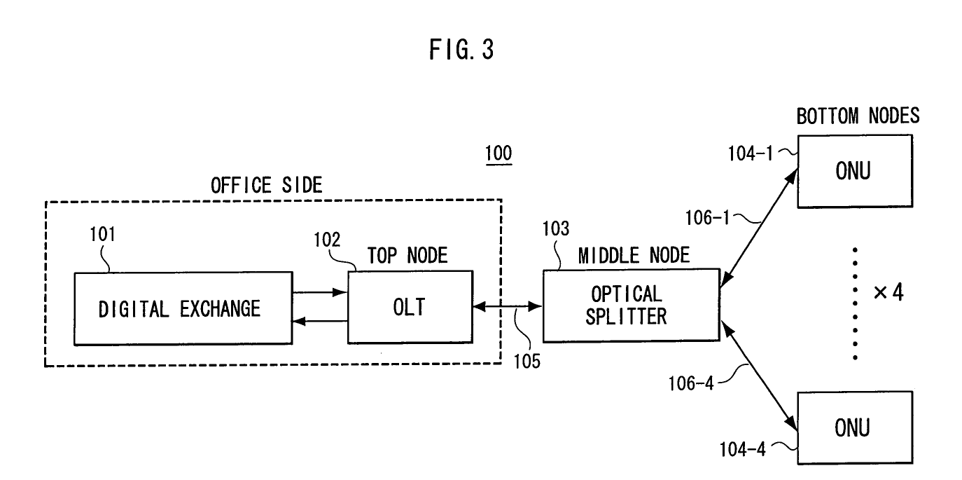

FIG. 3 is a block diagram showing basic structure of a bidirectional time division multiplexing optical communication network system of the embodiment.

In FIG. 3, a bidirectional time division multiplexing optical communication network system 100 of the embodiment is provided with a digital exchange 101 and an optical line terminal (OLT) 102 which serve as a office side structure, is provided with a plurality (four are shown in FIG. 3, but four is not a limitation) of optical network units (ONU) 104-1 to 104-4 which serve as subscriber side structures, and includes an optical splitter (optical branch circuit) 103. The OLT 102 and optical splitter 103 are connected together by a single optical fiber (optical fiber propagation path) 105. The ONUs 104-1 to 104-4 are connected with the optical splitter 103 by single optical fibers 106-1 to 106-4, respectively. Considering portions of a network that implements optical communications, the OLT 102 corresponds to a top node, the optical splitter 103 corresponds to a middle node and the ONUs 104-1 to 104-4 correspond to bottom nodes.

The bidirectional time division multiplexing optical communication network system 100 of this embodiment implements bidirectional optical communications between the OLT 102 and the plural ONUs 104-1 to 104-4 by time division multiplexing.

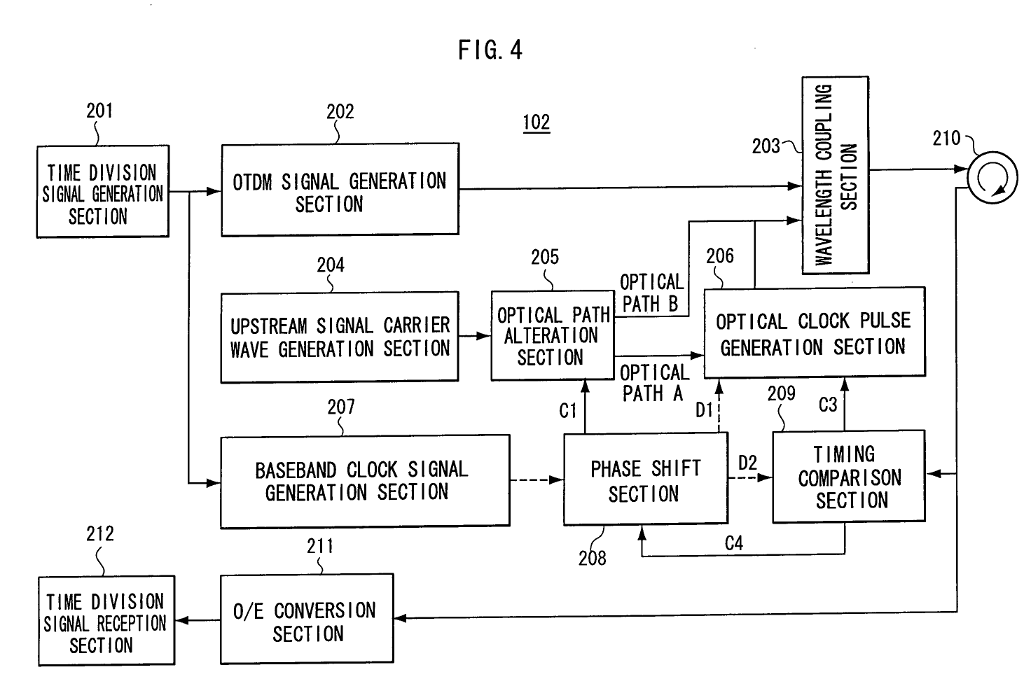

FIG. 4 is a block diagram showing detailed structure of the OLT 102 of the embodiment. The OLT 102 is provided with a time division signal generation section 201, an OTDM signal generation section 202, a wavelength coupling section 203, an upstream signal carrier wave generation section 204, an optical path alteration section 205, an optical clock pulse generation section 206, a baseband clock signal generation section 207, a phase shift section 208, a timing comparison section 209, an optical circulator 210, an O/E conversion section 211, and a time division signal reception section 212. Functions of these structural elements 201 to 212 of the OLT 102 will be clarified in operational descriptions hereafter.

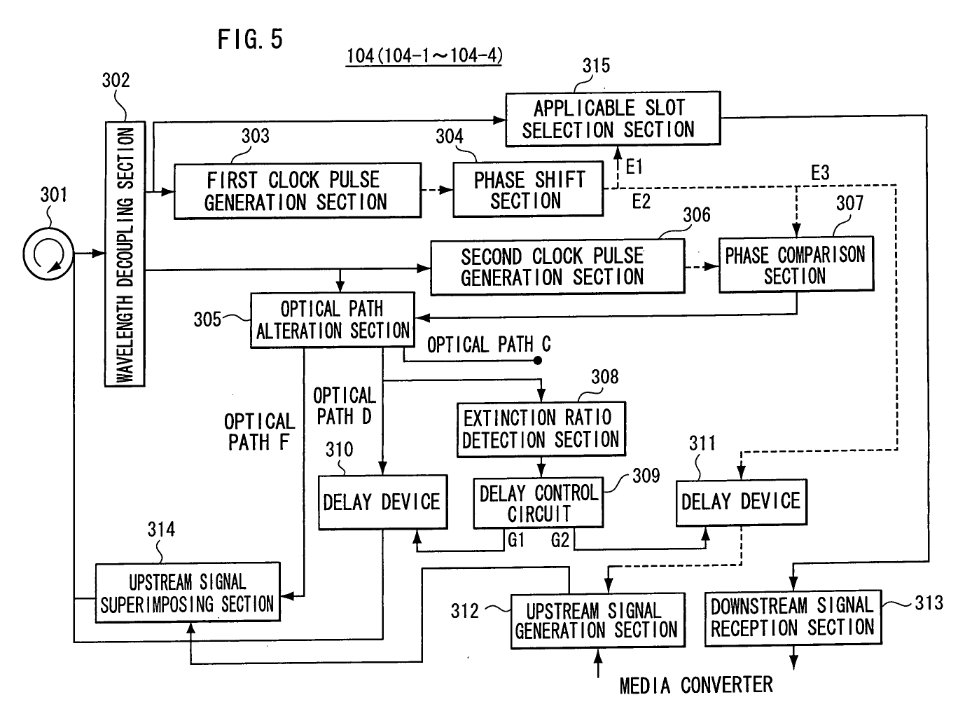

FIG. 5 is a block diagram showing detailed structure of the ONU 104 of the embodiment (104-1 to 104-4). Each ONU 104 is provided with an optical circulator 301, a wavelength decoupling section 302, a first clock pulse generation section 303, a phase shift section 304, an optical path alteration section 305, a second clock pulse generation section 306, a phase comparison section 307, an extinction ratio detection section 308, a delay control circuit 309, delay devices 310 and 311, an upstream signal generation section 312, a downstream signal reception section 313, an upstream signal superimposing section 314, and an applicable slot selection section 315. Functions of these structural elements 301 to 315 of the ONU 104 will be clarified in operational descriptions hereafter.

### Operation of the Embodiment

Now, operation of the bidirectional time division multiplexing optical communication network system of the embodiment will be described. In particular, operations (i.e., a control method) relating to control of time slots, for establishing synchronization of upstream signals from the ONUs 104 (104-1 to 104-4) toward the OLT 102, will be described.

Operations relating to control of time slots for establishing synchronization, that is, synchronization establishment operations, are executed, for example, immediately after each element of the bidirectional time division multiplexing optical communication network system has been put in place and startup has been enabled, that is, when the bidirectional time division multiplexing optical communication network system is starting up.

Details of the method of this embodiment will be explained hereafter. As will be described below, this is a method in which synchronization of all the ONUs 104-1 to 104-4 is established by synchronization establishment of the individual ONUs being performed in sequence. That is, the OLT 102 designates one of the plurality of ONUs 104-1 to 104-4, forms a feedback loop between the OLT 102 and the designated ONU 104-i, and establishes synchronization with the ONU 104-i. Thereafter, the OLT 102 designates another ONU 104-j and uses a feedback loop to establish synchronization therewith in the same manner as described above.

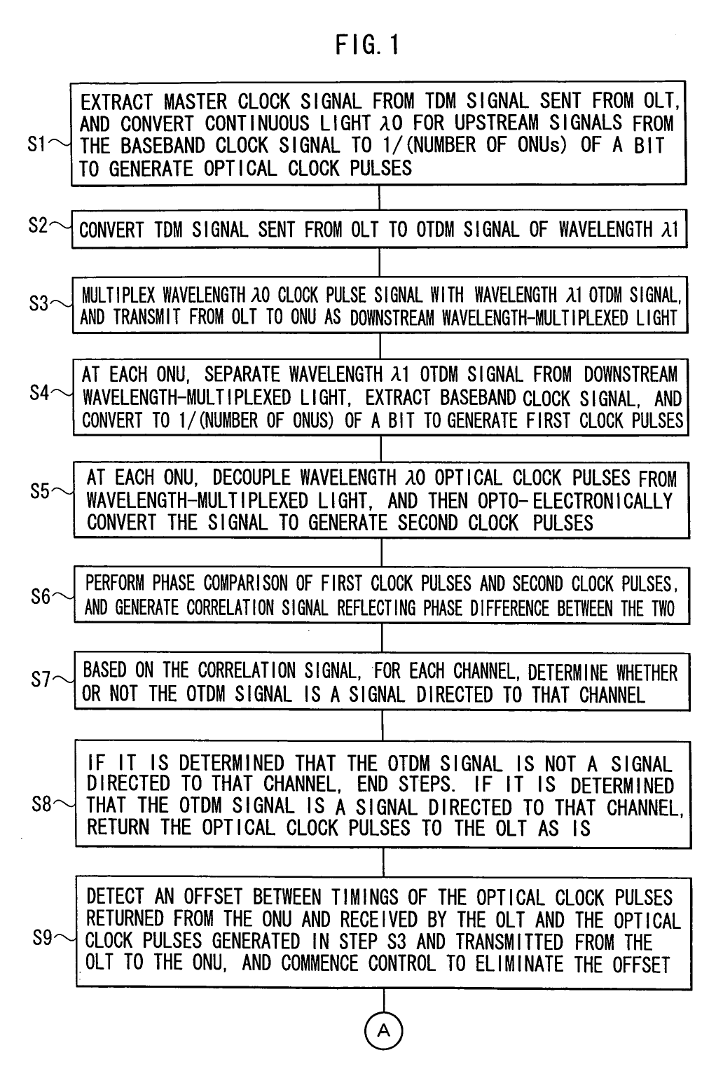

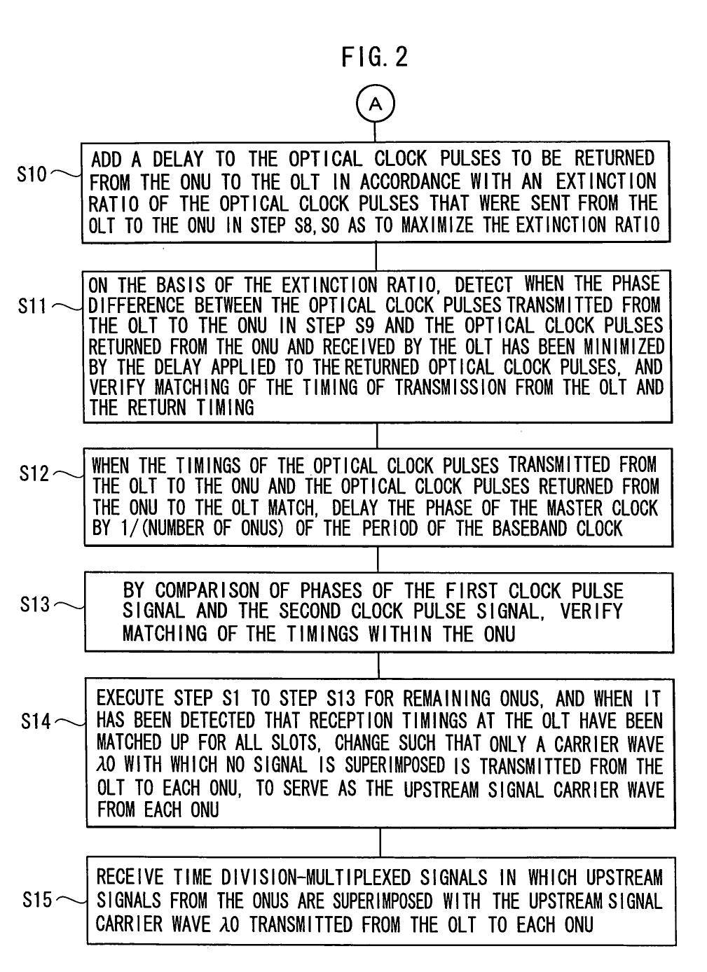

FIG. 1 and FIG. 2 are a flowchart showing a flow of timeslot control operations (synchronization establishment operations).

In an initial state, the optical path alteration section 205 of the OLT 102 selects an optical path A, and the optical path alteration section 305 of each of the ONUs 104-1 to 104-4 selects an optical path C. The end of the optical path C is terminated. In the following descriptions, a sequence of designation of the ONUs 104-1 to 104-4 by the OLT 102 is given as a sequence from the ONU 104-1 to the ONU 104-4.

Step S1:

In step S1, speaking broadly, a master clock signal (baseband clock signal) is extracted from a TDM signal (time division signal) transmitted from the OLT 102. A continuous light for upstream signals (upstream signal carrier wave) λ0 is inputted. Optical clock pulses are generated with a pulse width being a period of 1/(the number of ONUs) of a one-bit period of the master clock signal (baseband clock signal). The pulse width may be narrower than this.

Below, details of step S1 will be described. At the OLT 102, the baseband clock signal generation section 207 extracts the baseband signal in accordance with a time division signal (electronic signal) generated by the time division signal generation section 201, which includes signals to the plurality of ONUs 104-1 to 104-4 in time divisions, and outputs the baseband signal to the phase shift section 208 to serve as the master clock signal which is an electronic signal. As the baseband clock signal generation section 207, for example, a commercially available phase synchronization circuit or the like may be used, and as the phase shift section 208, a commercially available delay circuit for electronic signals may be used. The time division signal during synchronization establishment operations is not for regular communications, and therefore may be a pre-prepared dummy.

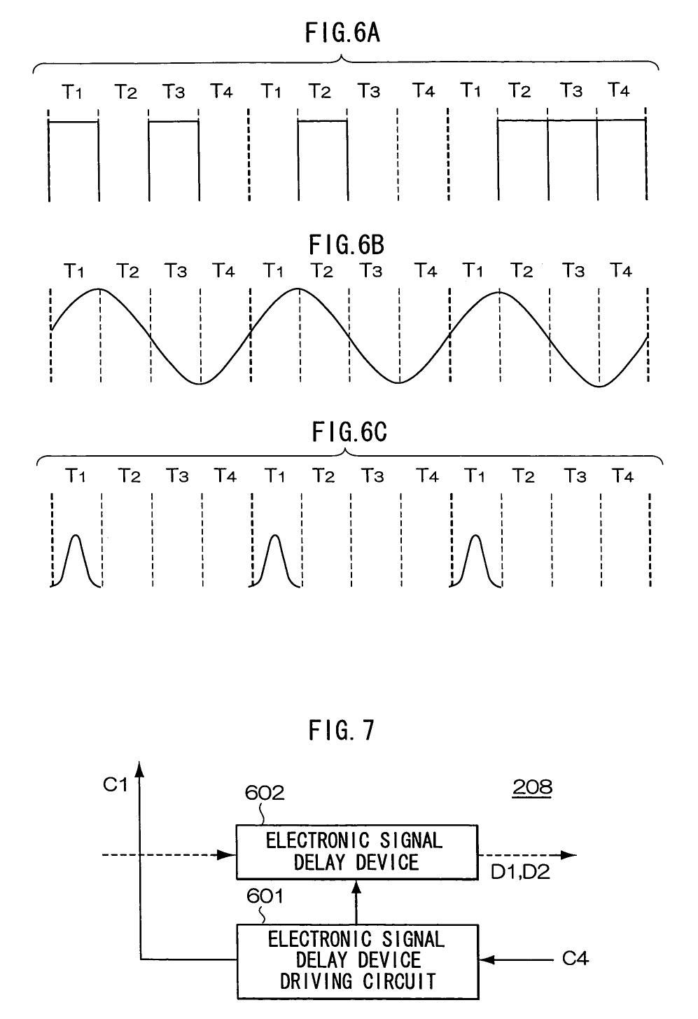

For example, the baseband clock signal generation section 207 forms a baseband clock signal, as shown in FIG. 6B, which is synchronized with the time division signal on the basis of a time division signal as shown in FIG. 6A and, moreover, has a one-bit interval of the time division signal as one period.

Each time a significant shift instruction C4 is provided from the timing comparison section 209, the phase shift section 208 increases a shift amount by 2π/(the number of ONUs). Considered in functional terms, the phase shift section 208 implements a phase shift in accordance with the ONU 104 (104-1 to 104-4) that is an object of synchronization establishment at that time. In the case of the example in FIG. 3, because the number of ONUs is four, shift amounts differ by π/2, which is 2π divided by 4. For example, when the synchronization establishment object is the ONU 104-1, the shift amount is π/2 (this is an initial condition state), when the synchronization establishment object is the ONU 104-2, the shift amount is π, when the synchronization establishment object is the ONU 104-3, the shift amount is 3π/2, and when the synchronization establishment object is the ONU 104-4, the shift amount is 2π. Baseband signals (electronic signals) subsequent to the phase shifts (including a shift amount of zero) D1 and D2 are provided from the phase shift section 208 to the optical clock pulse generation section 206 and the timing comparison section 209.

FIG. 7 is a block diagram showing a detailed structural example of the phase shift section 208. The phase shift section 208 is formed with an electronic signal delay device 602, which delays the baseband clock signal, and an electronic signal delay device driving circuit 601, which changeably controls a delay amount at the electronic signal delay device 602. The electronic signal delay device driving circuit 601 switches a shift amount thereof each time the significant shift instruction C4 is provided from the timing comparison section 209. When a significant shift instruction C4 is provided after the electronic signal delay device driving circuit 601 has switched through all shift amounts (see step S14, which will be described later), the electronic signal delay device driving circuit 601 outputs an instruction signal C1 to the optical path alteration section 205 to change from the optical path A to the optical path B. The electronic signal delay device driving circuit 601 and/or the electronic signal delay device 602 may employ, for example, commercially available devices.

The upstream signal carrier wave generation section 204 generates a carrier wave for upstream signals (continuous light λ0). The generated continuous light λ0 is provided to the optical clock pulse generation section 206 via the optical path alteration section 205. From this step S1 until a later-described step S13, the optical path alteration section 205 selects the optical path A to provide the continuous light λ0 to the optical clock pulse generation section 206. As the upstream signal carrier wave generation section 204, for example, a commercially available DFB laser may be used, and as the optical path alteration section 205, a commercially available MEMS switch may be used.

At the optical clock pulse generation section 206, the continuous light %0 provided from the optical path alteration section 205 is modulated by the phase-shifted baseband clock signal D1 provided from the phase shift section 208, and optical clock pulses with a pulse amplitude which is a ¼-period of the baseband clock signal (¼ of a period because the number of ONUs is four) are generated. FIG. 6C shows the optical clock pulses generated by the optical clock pulse generation section 206, which are optical clock pulses for when the synchronization establishment object is the ONU 104-1. If the synchronization establishment signal were the ONU 104-2, the optical clock pulses would appear only in the time slots T2 of FIG. 6A to FIG. 6C. The optical clock pulses shown in FIG. 6C are, strictly speaking, an amplitude modulated wave in which the carrier wave of wavelength λ0 is enveloped into the pulse shapes. However, these are referred to as optical clock pulses hereafter.

As the optical clock pulse generation section 206, it is possible to employ a section which electronically converts the baseband clock signal to the ¼-bit length with a commercially available electronic circuit and converts the same to an optical signal, a section which provides short pulses using an EA modulator (electro-absorption modulator), or the like. Herebelow, a case in which the latter of these two is used will be described.

FIG. 8 is a block diagram showing a structural example of the optical clock pulse generation section 206 that uses an EA modulator. The optical clock pulse generation section 206 is structured with an electronic signal amplifier control circuit 401, an electronic signal amplifier 402, and an EA modulator 403.

The electronic signal amplifier 402 is a device which amplifies the baseband clock signal and applies the same to a control terminal of the EA modulator 403. As shown in FIG. 9, the EA modulator 403 is a device which alters a loss of input light in accordance with a bias applied to the control terminal. When the baseband clock signal is applied to the control terminal of the EA modulator 403, loss of the input light is altered roughly sinusoidally. When the loss is small, the input light is transmitted through the EA modulator 403 and becomes output light. Thus, the optical clock pulses as shown in FIG. 6C are generated. The electronic signal amplifier control circuit 401 is a circuit which controls an amplification ratio of the electronic signal amplifier 402 in accordance with an output C3 from the timing comparison section 209, which will be described later (see the later-described step S11).

Step S2:

In step S2, the TDM signal (time division signal) transmitted from the OLT 102 is electro-optically converted to an OTDM signal of which a wavelength is λ1. That is, the OTDM signal generation section 202 converts the TDM signal (time division signal, see FIG. 6A) outputted from the time division signal generation section 201 to the OTDM signal and provides the same to the wavelength coupling section 203.

Step S3:

In step S3, the optical clock pulses with wavelength λ0 and the OTDM signal with wavelength λ1 are coupled, and transmitted toward the ONUs 104 (104-1 to 104-4) as downstream wavelength-multiplexed light. That is, the wavelength coupling section 203 wavelength-multiplexes the optical clock pulses outputted from the optical clock pulse generation section 206 with the OTDM signal outputted from the OTDM signal generation section 202. The optical circulator 210 sends this wavelength-multiplexed light to a propagation path. As the wavelength coupling section 203, for example, a commercially available AWG (arrayed waveguide grating) may be employed.

Step S4:

In step S4, broadly speaking, at each of the ONUs 104-1 to 104-4, the OTDM signal with wavelength λ1 is split from the downstream wavelength-multiplexed light, the baseband clock signal is extracted and converted to 1/(the number of ONUs) bits (=a ¼-bit), and first clock pulses are generated.

That is, the wavelength-multiplexed light outputted from the OLT 102 is split into four by the optical splitter 103, and reaches each of the ONUs 104-1 to 104-4.

The wavelength-multiplexed lights (λ0 and λ1) that reach each ONU 104-1 to 104-4 are provided via the optical circulator 301 to the wavelength decoupling section 302, and the optical clock pulses with wavelength λ0 (see FIG. 6C) and the OTDM signal with wavelength λ1 (see FIG. 6A) are decoupled. The OTDM signal is provided to the first clock pulse generation section 303 and the applicable slot selection section 315, and the optical clock pulses are provided to the optical path alteration section 305 and the second clock pulse generation section 306.

The first clock pulse generation section 303 opto-electronically converts the OTDM signal and extracts the master clock signal. Then, clock pulses with a length of ¼ of a bit of the master clock signal (the first clock pulses) are generated electronically. The first clock pulse generation section 303 may be realized by, for example, a commercially available opto-electronic converter and phase synchronization circuit, a filter circuit, and a filter. The phase shift section 304 applies a delay (a constant phase shift) to the first clock pulses in accordance with an ID (identification information) of this unit (ONU). For example, the phase shift section 304 of the ONU 104-1 does not execute a phase shift (i.e., the shift amount is 0), and the phase shift section 304 of the ONU 104-2 applies a phase shift of ¼ of the period of the master clock signal. In general, the ONU 104-n is set up so as to add a delay of (n-1)/4 of the period of the master clock signal. The phase shift section 304 may utilize, for example, a commercially available electronic signal delay device. Output signals from the phase shift section 304 (which are shown as three-way split signals E1, E2 and E3 in FIG. 5) are provided to the applicable slot selection section 315, the phase comparison section 307 and the delay device 311.

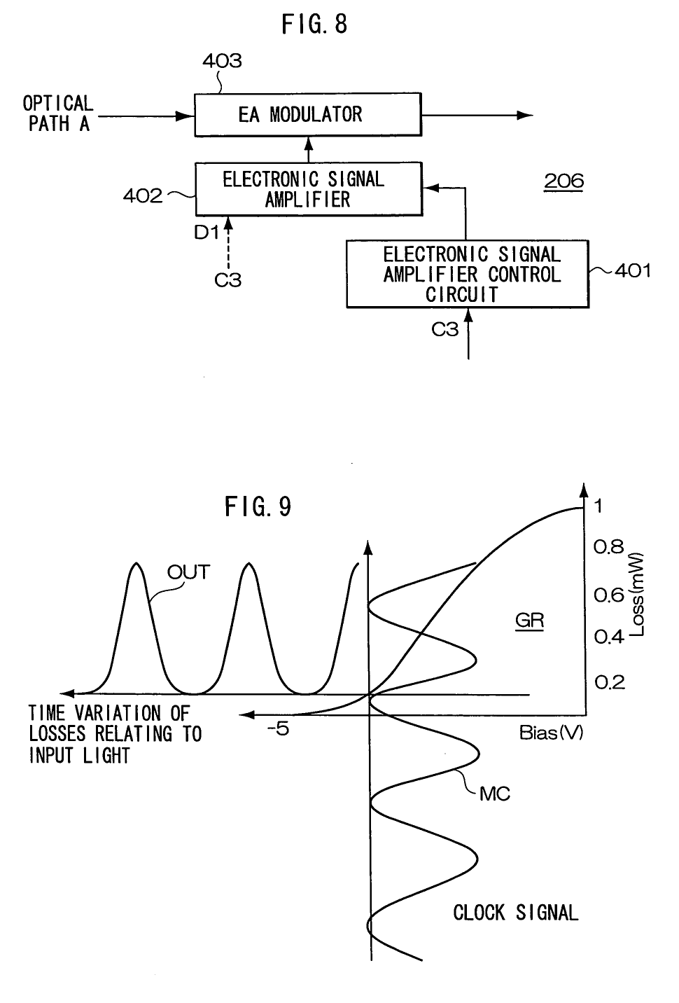

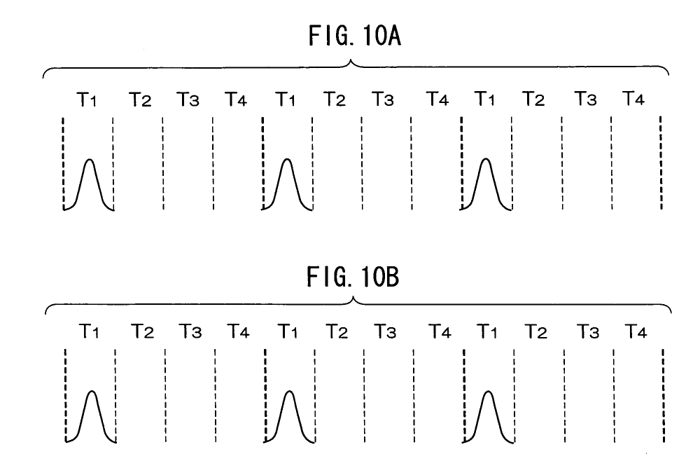

FIG. 10A shows first clock pulses outputted from the phase shift section 304 of the ONU 104-1.

Although not shown in the drawing, the first clock pulses outputted from the phase shift section 304 of the ONU 104-2 have a waveform of pulses in the time slots T2 of FIG. 10A, the first clock pulses outputted from the phase shift section 304 of the ONU 104-3 have a waveform of pulses in the time slots T3 of FIG. 10A, and the first clock pulses outputted from the phase shift section 304 of the ONU 104-4 have a waveform of pulses in the time slots T4 of FIG. 10A.

Step S5:

Step S5 is a step in which, at each ONU 104-1 to 104-4, the optical clock pulses with wavelength λ0 which have been obtained by decoupling from the wavelength-multiplexed light are opto-electronically converted to generate a second clock pulse signal. That is, the second clock pulse generation section 306 opto-electronically converts the optical clock pulses with wavelength λ0 which have been provided from the wavelength decoupling section 302, and provides the obtained clock pulses, which are electronic signals, (the second clock pulses) to the phase comparison section 307.

FIG. 10B shows the second clock pulses outputted from the second clock pulse generation section 306.

Step S6:

In step S6, at each ONU 104-1 to 104-4, a phase comparison between the first clock pulse signal and the second clock pulse signal is performed, and a correlation signal reflecting a phase difference between the two is generated.

The phase comparison section 307 compares phases of the first clock pulses from the phase shift section 304, which have been generated by step S4, and the second clock pulses from the second clock pulse generation section 306, which have been generated by step S5, and generates the correlation signal. The phase comparison section 307 uses, for example, a commercially available multiplication circuit to multiply the first clock pulses with the second clock pulses and, by comparing a multiplication result with a threshold value, identifies a degree of correlation between the two clock pulses. Then, for example, a result of the comparison between the multiplication result and the threshold value is inputted to a D-FF (delay flip-flop) or the like and is retained, and an output signal of the D-FF, which is a zero or a one, serves as the correlation signal.

Step S7:

In step S7, at each ONU 104-1 to 104-4, on the basis of the correlation signal between the first clock pulses and the second clock pulses, it is determined whether or not the OTDM signal with wavelength λ1 is a signal which has been directed to that channel (a channel-matching identification step). That is, the phase comparison section 307 performs an identification of whether or not that ONU is the destination of the optical clock pulses from the OLT 102 in accordance with the correlation signal generated on the basis of the phase difference between the first clock pulses and the second clock pulses. In a case in which, as described above, a multiplication result is compared with a threshold value and a comparison result thereof is retained to generate the correlation signal, the correlation signal becomes a channel-matching identification signal as is.

If the second clock pulses obtained by opto-electronically converting the optical clock pulse (with wavelength λ0) from the OLT 102 are as shown in FIG. 10B, the phase comparison section 307 of the ONU 104-1 which generates the first clock pulses shown in FIG. 10A determines that the correlation between the first clock pulses and the second clock pulses is high and that that ONU is the destination. On the other hand, the phase comparison sections 307 of the other ONUs 104-2 to 104-4 determine that the destination ONU is another ONU therefrom.

Step S8:

In step S8, at each ONU 104-1 to 104-4, if it has been judged by the channel-matching identification of step S7 that the OTDM signal is not a signal directed to that channel, the step S8 promptly ends. If it has been judged that the OTDM signal is a signal directed to that channel, then the optical clock pulses with wavelength λ0 are returned to the OLT 102 without alteration. Thus, a feedback loop is formed.

Where the OTDM signal is a signal directed to that channel, the phase comparison section 307 outputs a control signal to the optical path alteration section 305 to change from the default optical path C to an optical path D. Meanwhile, where the OTDM signal is not a signal directed to that channel, the phase comparison section 307 promptly ends processing. Hence, the optical path alteration section 305 continues in a state in which the default optical path C is selected. As the optical path alteration section 305, for example, a commercially available MEMS (micro-electronic mechanical system) switch may be employed.

Where the optical path D is switched to by the optical path alteration section 305, the optical clock pulses with wavelength ?0 are provided to the extinction ratio detection section 308 and the delay device 310.

Output light from the delay device 3 10 (the optical clock pulses) is then provided to the optical circulator 301. That is, the optical clock pulses with wavelength λ0 that have been transmitted by the OLT 102 and have reached the optical circulator 301 are provided to the optical circulator 301 via the optical path alteration section 305 and the delay device 310, and are sent to the OLT 102. Thus, the feedback loop of the optical clock pulses is formed within that ONU 104 (104-1).

The ONU that forms the feedback loop of the optical clock pulses in this manner is the only ONU at which the optical path alteration section 305 selects the optical path D. When the optical path alteration section 305 of the ONU 104-1 has selected the optical path D, the optical clock pulse feedback loop is formed only at the ONU 104- 1, whereas optical clock pulse feedback loops are not formed at the other ONUs 104-2 to 104-4.

Step S9:

In steps S9 to S11, the ONU at which the optical path alteration section 305 has selected the optical path D (first the ONU 104- 1) and the OLT 102 work together to control feedback, and hence establishment of synchronization of upstream signals is achieved for that ONU.

In step S9, speaking broadly, an offset in timings between the optical clock pulses returned from the ONU at which the optical path alteration section 305 has selected the optical path D (first the ONU 104- 1) and the optical clock pulses of wavelength λ0 that were generated in the earlier-described step S1, and which were transmitted from the OLT 102 to the ONUs 104, is detected, and control to eliminate the offset is commenced.

At the ONU 104-1, which has been identified as the destination channel by the channel-matching identification, the optical clock pulses outputted to the optical channel D are split into two, of which one part is inputted to the extinction ratio detection section 308. The extinction ratio detection section 308 detects an extinction ratio and sends the same to the delay control circuit 309. In accordance with the extinction ratio, the delay control circuit 309 outputs the same delay control command to the delay devices 310 and 311, via control signal paths G1 and G2. As the extinction ratio detection section 308, it is possible to employ, for example, a structure in which an inputted optical signal is opto-electronically converted by a commercially available opto-electronic converter and then a voltage signal in accordance with an extinction ratio is obtained using a commercially available extinction ratio monitoring device.

Step S10:

In step S10, at the ONU 104-1 which has been identified as the destination channel by the channel-matching identification, a delay is applied to the optical clock pulses with wavelength λ0 that are returned from this ONU 104-1 to the OLT 102, in accordance with the extinction ratio of the optical clock pulses with wavelength λ0 that have arrived, so as to maximize the extinction ratio.

That is, the delay control circuit 309 carries out control of the delay devices 310 and 311 such that the extinction ratio of the optical clock pulses inputted to the extinction ratio detection section 308 is made as large as possible. The delay control circuit 309 outputs control signals and controls the delay amounts of the delay devices 310 and 311 so as to increase the extinction ratio as much as possible. These may be realized by, for example, utilizing commercially available electronic circuits.

Step S11:

In step S11, broadly speaking, by the application in the above-described step S10 of a delay to the optical clock pulses with wavelength λ0 that are returned to the OLT 102 from the ONU 104-1 that has been identified as the channel destination, a phase difference between the optical clock pulses with wavelength λ0 that are transmitted from the OLT 102 to the ONU 104-1 in the above-described step S9 and the optical clock pulses with wavelength λ0 that are returned from the ONU 104-1 and received at the OLT 102 is minimized, and this minimization is sensed on the basis of the extinction ratio. Thus, matching with optimal accuracy of a transmission timing from the OLT 102 and a reception timing is confirmed.

After a delay has been applied by the delay device 310, the optical clock pulses returned to the OLT 102 pass through the optical circulator 210 at the OLT 102 and are hence split and inputted to the timing comparison section 209.

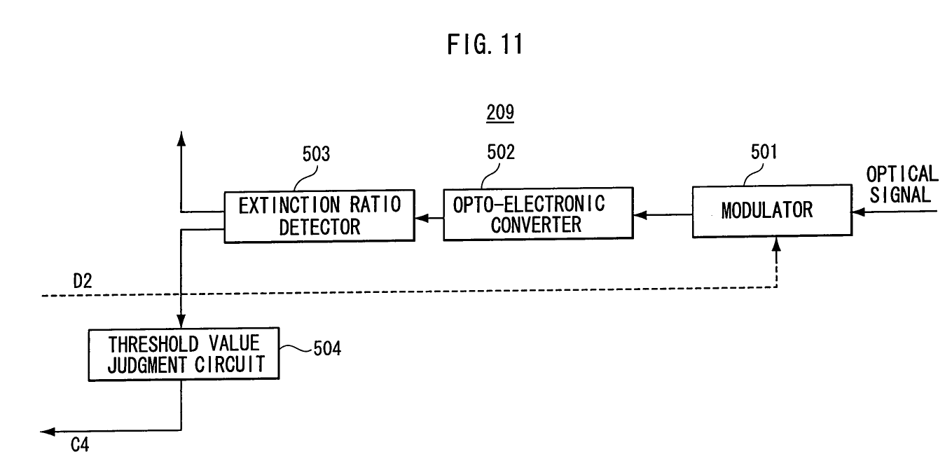

FIG. 11 is a block diagram showing an example of internal structure of the timing comparison section 209. The timing comparison section 209 includes a modulator 501, an opto-electronic converter 502, an extinction ratio detector 503 and a threshold value judgment circuit 504.

The modulator 501 is, for example, an EA modulator. On the basis of a timing difference between the optical clock pulses provided from the optical circulator 210 and the master clock signal (D2) provided from the phase shift section 208, the modulator 501 alters an extinction ratio of optical clock pulses outputted from the modulator 501. The optical clock pulses of which the extinction ratio has been altered are converted to an electronic signal by the opto-electronic converter 502, and are sensed by the extinction ratio detector 503. The detected extinction ratio is provided to the optical clock pulse generation section 206 and the threshold value judgment circuit 504. The optical clock pulse generation section 206 sets a peak value of the optical clock pulses that are generated thereat in accordance with the extinction ratio. The threshold value judgment circuit 504, as illustrated in a later-described step S13, compares the detected extinction ratio with a predetermined threshold value, and accordingly determines whether or not synchronization has been established for the channel (ONU) that is the current synchronization establishment object.

The modulator 501 and the opto-electronic converter 502 may be implemented using, for example, commercially available products, and the extinction ratio detector 503 may be implemented with commercially available products as mentioned earlier. The threshold value judgment circuit 504 may also be implemented with an electronic circuit which is a commercially available product.

A reason for altering the extinction ratio of the output pulses in accordance with dynamic characteristics of the EA modulator 501 will now be explained with reference to FIG. 9. A graph GR in FIG. 9 shows a transmission characteristic of light with a bias voltage inputted to the EA modulator 501. When the master clock signal MC (that is, a sinusoidal signal) is inputted to the EA modulator 501 to serve as a modulating signal (i.e., bias voltage), a variation over time OUT of the light transmission characteristic has a repetitive pulse form. A power of the output light is a power which is a multiple of this pulse-form transmission characteristic OUT with the inputted optical clock pulses. Therefore, in simple terms, the EA modulator 501 can be regarded as a multiplier of a signal representing variations over time in the light transmission characteristic with the inputted optical clock pulses. When the master clock signal and the optical clock pulses are being inputted simultaneously, the extinction ratio of output light from the EA modulator 501 is at a maximum when timings of the two match with good accuracy. Therefore, the EA modulator 501 can be used for timing control of the optical clock pulses.

The extinction ratio of the output signal from the EA modulator 501 is detected by the extinction ratio detector 503. A voltage signal (C3) which is proportional to the extinction ratio is provided to the electronic signal amplifier control circuit 401 (FIG. 8), which is a structural element of the optical clock pulse generation section 206, and controls an amplitude of the sinusoidal voltage outputted from the electronic signal amplifier 402.

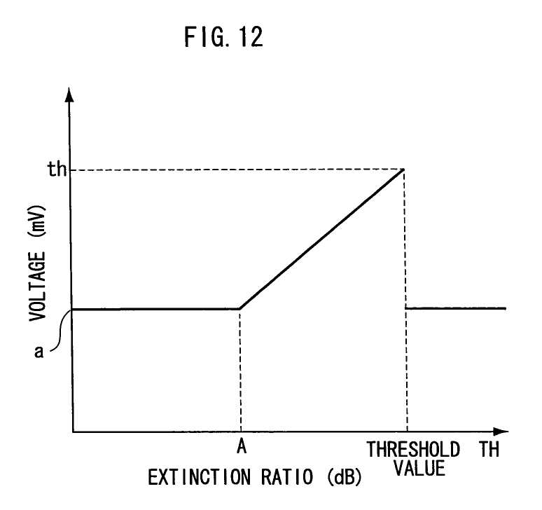

FIG. 12 is an explanatory diagram showing a relationship of the extinction ratio and the output voltage from the electronic signal amplifier control circuit 401 (i.e., an amplification ratio of the electronic signal amplifier 402). The electronic signal amplifier control circuit 401 sets the output voltage to a constant voltage, a, when the extinction ratio is at or below a value A. When the extinction ratio is in a range above the value A and below a threshold value TH, the output voltage is proportional to the extinction ratio so as to run between the voltage a and a voltage th. When the extinction ratio is greater than the threshold value TH, the output voltage is at the constant voltage a.

By such operation of the electronic signal amplifier control circuit 401, the extinction ratio (power) of the optical clock pulses from the EA modulator 403 of the optical clock pulse generation section 206 (that is, optical clock pulses sent to the ONU 104) is reduced in a case in which the offset of the timings of the two signals detected by the timing comparison section 209 is large (an out-of-synchronization quantity), and increases as the offset becomes smaller. Incidentally, the EA modulator 403 of the optical clock pulse generation section 206 also follows the characteristic shown in the graph of FIG. 9. The extinction ratio of the optical clock pulses sent to the ONU 104 is detected at the ONU 104-1 that is the current synchronization establishment object. Delay control is implemented in the ONU 104-1 such that the extinction ratio is made as large as possible. That is, the OLT 102 notifies the ONU 104-1 of the out-of-synchronization quantity by means of the extinction ratio (power) of the optical clock pulses. In the ONU 104-1, the extinction ratio detection section 308 detects this extinction ratio and notifies the same to the delay control circuit 309. In accordance with the detected extinction ratio, the delay control circuit 309 controls the delay amount of the delay device 310 such that the extinction ratio will become a certain value. In short, the timings of the two signals compared by the timing comparison section 209 being excellently matched controls the extinction ratio of the optical clock pulses outputted toward the ONU 104-1 such that the extinction ratio thereof is the certain value.

By delay control using a feedback loop of optical clock pulses as described above, timings at which pulses from the ONU 104-1 reach the OLT 102 can be set to desired timings (i.e., establishment of synchronization).

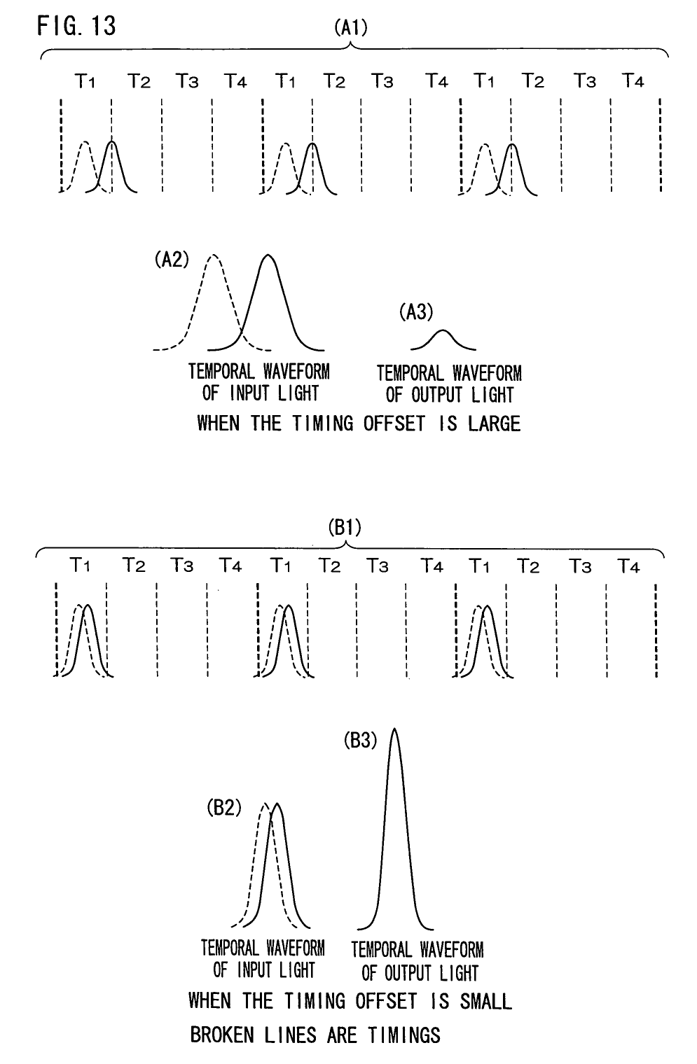

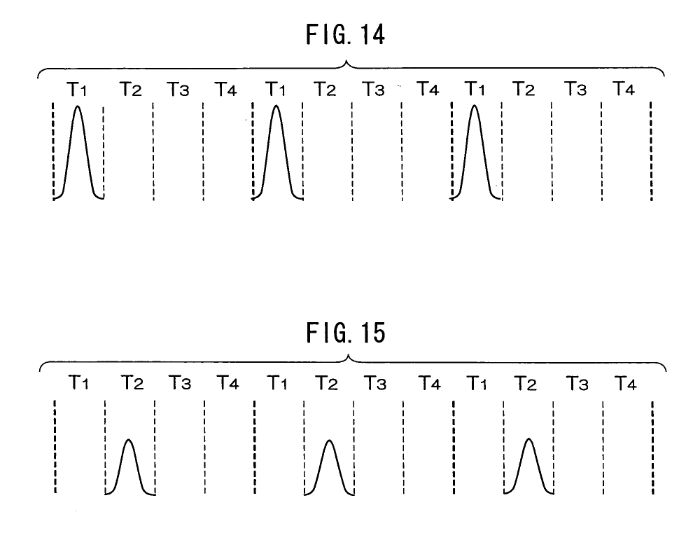

FIG. 13(A1) to FIG. 13(A3) and FIG. 13(B1) to FIG. 13(B3) are explanatory views showing profiles of the optical clock pulses outputted from the EA modulator 501 for offsets of the timings of the two signals into the EA modulator 501. In FIG. 13(A1) to FIG. 13(A3) and FIG. 13(B1) to FIG. 13(B3), the broken lines show timings of ideal optical clock pulses for the upstream direction, which are set from phases of the master clock signals provided from the phase shift section 208. FIG. 13(A1) and FIG. 13(A2) show a case in which the timing of optical clock pulses inputted to the EA modulator 501 is greatly offset from the ideal timing. In such a case, a peak value (extinction ratio) of the optical clock pulses outputted from the EA modulator 501 is small, as shown in FIG. 13(A3). In contrast, FIG. 13(B1) and FIG. 13(B2) show a case in which the timing of optical clock pulses inputted to the EA modulator 501 is hardly offset at all from the ideal timing. In such a case, the peak value of the optical clock pulses outputted from the EA modulator 501 is large, as shown in FIG. 13(B3). Therefore, by obtaining an extinction ratio at or above a certain threshold value, excellent matching of timings can be verified, and such a verification function is implemented by the threshold value judgment circuit 504. FIG. 14 shows profiles of optical clock pulses of the EA modulator 501 when the timing of optical clock pulses inputted to the EA modulator 501 matches the ideal timing.

Step S12:

In step S12, broadly speaking, when the timings of the optical clock pulses with wavelength λ0 transmitted from the OLT 102 to the ONU 104-1 in step S11 and the optical clock pulses with wavelength λ0 returned from the ONU 104-1 to the OLT 102 by the feedback loop in accordance with the application of a delay coincide, the phase of the master clock extracted by the OLT 102 is shifted (delayed) by an amount corresponding to 1/(the number of ONUs) of the period thereof (=¼ period when there are four ONUs).

During the implementation of feedback control in the above described step S11, when matching of the timing of the optical clock pulses inputted to the timing comparison section 209 and the ideal timing is verified by the threshold value judgment circuit 504 in the timing comparison section 209, a trigger signal (C4) is provided to the phase shift section 208.

When the electronic signal delay device driving circuit 601 of the phase shift section 208 receives this trigger signal, the electronic signal delay device 602 performs control so as to phase-shift (delay) the inputted master clock signal (baseband clock signal) by a further ¼-period from the present shift amount.

The optical clock pulse generation section 206 is provided with the baseband clock signal which has been phase-shifted by a ¼-period from the previous state, and correspondingly alters the phase of the optical clock pulses that are outputted. FIG. 15 shows a waveform of the optical clock pulses superimposed with the upstream carrier light λ0, which is transmitted from the OLT 102, when step S12 has been completed.

This alteration of the timing (phase) of the optical clock pulses equates to changing the synchronization establishment object from the previous ONU 104-1 to the next ONU 104-2.

Step S13:

In step S13, broadly speaking, inside the ONU 104 that was the synchronization establishment object hitherto (ONU 104-1), by phase comparison of the optical clock pulses transmitted from the OLT 102 (the second clock pulses) with the first clock pulses formed on the basis of the OTDM signal transmitted from the OLT 102, it is verified that the timings match (i.e., that synchronization has been established).

Consequent to the phase-shift operation at the OLT 102 in the above-described step S12, a correlation signal ‘0’ is outputted from the phase comparison section 307 of the ONU 104-1. At this moment, the optical path alteration section 305 alters the setting of the optical path from optical path D to optical path F, which traverses the upstream signal superimposing section 314. Thus, at the ONU 104-1, synchronization of upstream and downstream time slots is established.

At this time, the first clock pulses, which are outputted to path E3, are being provided to the delay device 311. The delay device 311 is controlled in a similar manner to the delay device 310 by the delay control circuit 309. That is, a delay amount the same as for the second clock pulses is applied to the first clock pulses by the delay device 311 via the delay device 310. Thus, upstream signals are superimposed with the first clock pulses using, for example, a commercially available modulator, and hence the OLT 102 can receive the upstream signals in correct time slots.

A ¼-bit delay circuit or the like is installed at the upstream signal generation section 312. An upstream signal inputted from a media converter side is superimposed with the delayed first clock pulses by a multiplier circuit or the like, and thus upstream signals (upstream electronic pulse signals) can be generated. The pulses are disposed in slot portions corresponding to this ONU 104-1, and these electronic signals are superimposed with the upstream direction carrier wave by the upstream signal superimposing section 314. The upstream signal superimposing section 314 includes, for example, a modulator which intensity-modulates the upstream direction carrier wave in accordance with the upstream electronic pulse signals.

Moreover, for example, a commercially available modulator is installed at the applicable slot selection section 315. The downstream OTDM signal is inputted thereto and modulated with the first clock pulses. Portions of the downstream OTDM signal for which this ONU 104-1 is the destination are extracted by multiplication results. The downstream signal reception section 313 is equipped with, for example, a commercially available bandpass filter or the like, which broadens a pulse width of the optical short pulse signal that is received, and converts the same to a waveform which can be received by the media converter.

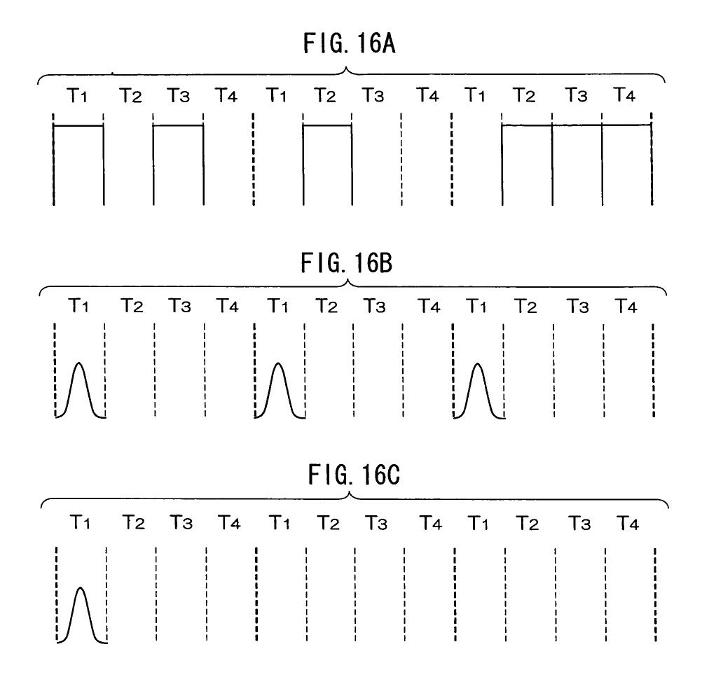

FIG. 16A to FIG. 16C are signal wavecharts showing waveforms of input signals and output signals of the applicable slot selection section 315. In a case in which the downstream OTDM signal changes with the sequence ‘1,0,0 . . . ’ for the time slots T1 as shown in FIG. 16A, in this ONU 104-1, the first clock pulses appear in the time slots T1 as shown in FIG. 16B, and thus the output signals from the applicable slot selection section 315, as shown in FIG. 16C, are results of multiplication therewith. That is, the time slots T1 change in the sequence ‘1,0,0 . . . ’ and the other time slots T2 to T4 are all at 0.

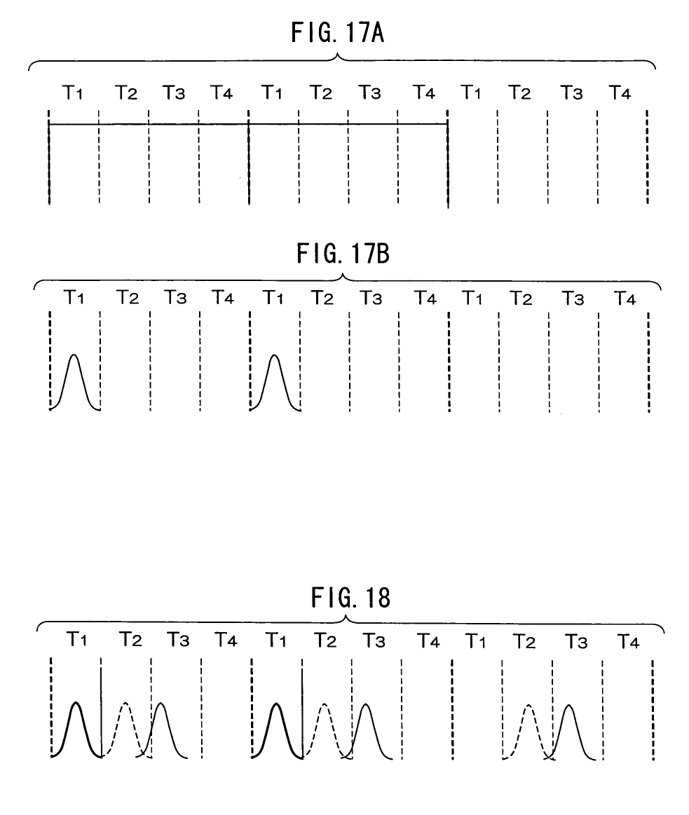

FIG. 17A and FIG. 17B are signal wavecharts showing waveforms of an upstream pulse signal from the ONU 104-1 and an upstream electronic pulse signal from the upstream signal generation section 312. The interval of the four time slots T1 to T4 is a one-bit interval of the upstream signal, and in this bit interval, the upstream signal is at 1 or 0. FIG. 17A shows a case in which the upstream signal is ‘1,1,0 . . . ’. The upstream signal generation section 312, by, for example, multiplication processing, passes the first clock pulses (electronic signal) provided from the delay device 311 when the upstream signal is 1, and blocks such passage when the upstream signal is 0, forming an upstream electronic pulse signal as shown in FIG. 17B.

Step S14:

In step S14, broadly speaking, the above-described steps S1 to S13 are sequentially executed for the remaining ONUs 104-2 to 104-4. When it is detected that timings of reception at the OLT 102 have been matched up for all time slots, upon this detection, the OLT 102 internally changes such that the baseband clock signal with wavelength λ0 is simply transmitted from the OLT 102 to each of the ONUs 104-1 to 104-4, to serve as upstream signal carrier waves from each of the ONUs 104-1 to 104-4.

When synchronization establishment with the ONU 104-1 ends, an operation for synchronization establishment with the ONU 104-2 is executed in the same manner as for the case of the ONU 104-1 (the optical clock pulses being in the time slots T2). When synchronization establishment with the ONU 104-2 ends, an operation for synchronization establishment with the ONU 104-3 is executed in the same manner as for the case of the ONU 104-1 (the optical clock pulses being in the time slots T3). When synchronization establishment with the ONU 104-3 ends, an operation for synchronization establishment with the ONU 104-4 is executed in the same manner as for the case of the ONU 104-1 (the optical clock pulses being in the time slots T4).

By the sequence of operations described above, timings of downstream signals from the ONUs 104-1 to 104-4 are matched with all the time slots. Then, the phase shift by the phase shift section 208 of the OLT 102 is shifted by an amount corresponding to one period of the baseband clock signal. At this moment, the electronic signal delay device driving circuit 601 of the phase shift section 208 instructs the optical path alteration section 205 to change the optical path from the optical path A to the optical path B.

Hence, a continuous light with wavelength λ0 with which signals are not superimposed is provided to the wavelength coupling section 203, and is transmitted via the wavelength coupling section 203 and the optical circulator 210 to each of the ONUs 104-1 to 104-4. At each of the ONUs 104-1 to 104-4, the upstream signal superimposing section 314 superimposes upstream signals (upstream electronic pulse signals) with the continuous light λ0 (carrier wave with wavelength λ0), which is sent to the optical path F by the optical path alteration section 305, and returns the same to the OLT 102.

For example, each of the ONUs 104-1 to 104-4 is notified by a downstream signal that synchronization has been established for all of the ONUs 104-1 to 104-4. Hence, upstream direction transmissions begin.

Step S15:

In step S15, the OLT 102 receives time division multiplexed signals, in which the upstream signals are superimposed with the wavelength %0 carrier waves, from each of the ONUs 104-1 to 104-4.

Timings of return of the signals in which the upstream signals are superimposed with the wavelength λ0 carrier waves from each of the ONUs 104-1 to 104-4 have been established by the processing described above. Therefore, this is time division multiplexing in which, having passed through the optical splitter 103, relationships with the time slots are appropriate. At the OLT 102, these time division multiplexed signals are provided from the optical circulator 210 to the O/E conversion section 211 and are converted to electronic signals, and are then provided to the time division signal reception section 212.

### Effects of the Embodiment

According to the embodiment described above, upstream direction synchronization from each of the ONUs 104-1 to 104-4 can be achieved without accurate distances from the optical splitter 103 to each of the ONUs 104-1 to 104-4 being defined.

Moreover, according to the embodiment described above, there is no need to establish synchronization by complex packet processing in an upper layer, for control or the like, for collision prevention of the upstream signals transmitted from the ONUs 104-1 to 104-4. That is, synchronization establishment can be performed using a control method which is not dependent on higher layers. Furthermore, it is sufficient for synchronization establishment operations to be executed only on occasions such as at a time of system installation, a time of maintenance and the like, and there is no need to perform continuous control. Therefore, power consumption can be lowered.

Moreover, as light sources there need only be two light sources, for downstream signals and for upstream signals. That is, there is no need to provide light sources proportional in number to the ONUs at the OLT, as in a WDM-PON. Therefore, it is possible to achieve effects similar to a WDM-PON, that is, the effect of it being possible to separately set upstream signals and downstream signals to matching bit rates, at lower cost.

Further yet, according to the embodiment described above, it is possible to execute downstream direction communications during upstream direction synchronization establishment.

### Other Embodiments

For the embodiment described above, a case in which the number of ONUs is four has been illustrated, but the number of ONUs may be an arbitrary number. As described earlier, it is sufficient for processing by the phase shift section 208 (i.e., phase shift amounts) and suchlike to be altered in accordance with the number of ONUs. Herein, the number of ONUs may even be one; in such a case, the timings of upstream signals may be set to timings designated by the OLT.

For the embodiment described above, a case has been illustrated in which units of phase shift amounts at the phase shift section 208 are ¼ of a bit interval. However, it is also possible to apply other units. For example, it would be possible to apply ¾ of a bit interval.

In the embodiment described above, the timing comparison section 209 detects a timing offset between the baseband clock signal which has been phase-shifted and the optical clock pulses which are fed back. However, it would also be possible for the timing comparison section 209 to detect a timing offset between the optical clock pulses generated by the optical clock pulse generation section 206 and the optical clock pulses which are fed back.

For the embodiment described above, a case has been illustrated in which upstream direction communications commence after synchronization has been established for all the ONUs. However it would be possible to execute upstream direction communication by an ONU for which synchronization has been established even without having established synchronization for all the ONUs.

FIG. 18 is an explanatory diagram for such a variant embodiment. FIG. 18 shows signals reaching the OLT 102 during the implementation of synchronization establishment for the ONU 104-2 with synchronization having been established for the ONU 104-1. Because synchronization has already been established for the time slots T1, an upstream signal from the ONU 104-1 is superimposed. For the time slots T2, the broken lines are an ideal timing of optical clock pulses returned from the ONU 104-2, and the solid line portions are the optical clock pulses that are received. Synchronization establishment processing to match the timing offset thereof is executed by the procedure described earlier.

During the performance of synchronization establishment for the ONU 104-2, in order to transmit upstream signals by the ONU 104-1, the embodiment described above may be altered as described below. At the OLT 102, the phase shift section 208 causes the optical path alteration section 205 to select the optical path B for the time slots T1, and causes the optical path alteration section 205 to select the optical path A for the time slots T2 to T4. At the ONU 104-1 for which synchronization has already been established, the optical path alteration section 305 activates the upstream signal generation section 312 in accordance with a change of the optical path to the optical path F. The second clock pulse generation sections 306 of the ONUs 104-1 to 104-4, on the basis of waveforms (envelope forms) after opto-electronic conversion, extract only optical clock pulses, and then generate the second clock pulses.

For the embodiment described earlier, a case has been illustrated in which a timing offset detected by the timing comparison section 209 is propagated to the ONU by an extinction ratio of optical clock pulses. However, propagation to the ONU by another method is also possible. For example, it is possible to employ a polarized light source as the light source, alter an inclination of a polarization plane from a reference plane in accordance with the timing offset, and propagate the same to the ONU. It is further possible to alter a number of pulses in one time slot interval in accordance with a timing offset and propagate the same to the ONU. It is also possible to give notice of the presence of an offset rather than giving notice of the size of an offset. In such a case, the delay device 310 alters a delay amount in unit amounts.

Embodiments of the present invention are described above, but the present invention is not limited to the embodiments as will be clear to those skilled in the art.

According to a first aspect of the invention, there is provided there is provided an upstream signal timing control method which controls a timing of an upstream optical signal, from a terminal device to a center device, to a timing that the center device intends, the upstream signal timing control method comprising: transmitting, from the center device to the terminal device, optical clock pulses synchronized with the timing that the center device intends; the terminal device controlling a delay of the optical clock pulses and returning the optical clock pulses to the center device; the center device detecting an offset between the timing and a timing of the returned optical clock pulses, and including information of the timing offset in the optical clock pulses that are being sent, and the terminal device performing the delay control in accordance with the information of the timing offset that has been included in the optical clock pulses that are received by the terminal device; and the center device verifying completion of timing control of the upstream optical signal, when the offset between the timing and the timing of the returned optical clock pulses is less than a threshold value.

According to a second aspect of the invention, there is provided a center device of an optical communication network system in which at least one terminal device is accommodated at the center device, the at least one terminal device and the center device forming a passive optical network, and the center device comprising: an optical clock pulse generation and transmission unit that generates and transmits optical clock pulses to a terminal device that is a current control terminal device, the optical clock pulses being synchronized with a timing of an upstream optical signal from the control terminal device to the center device; a timing comparison unit that detects an offset between the timing and a timing of the optical clock pulses that have been delay-controlled and returned from the control terminal device; a timing offset information addition unit that, when the detected timing offset is larger than a threshold value, adds information of the timing offset to the optical clock pulses and transmits the same to the control terminal device; and a timing control completion verification unit that verifies completion of timing control of the upstream optical signal for the control terminal device when the detected timing offset is less than the threshold value.

According to a third aspect of the invention, there is provided a terminal device of an optical communication network system in which at least one of the terminal device is accommodated at a center device, the terminal device and the center device forming a passive optical network, and the terminal device comprising: an optical clock pulse returning unit that returns optical clock pulses which have arrived from the center device; and a delay unit that delays the optical clock pulses to be returned in accordance with timing offset information which has been applied to the optical clock pulses arriving from the center device.

A fourth aspect is an optical communication network system in which at least one of terminal device is accommodated at a center device, the terminal device and the center device forming a passive optical network, and the system employing a center device of the second aspect as the center device and a terminal device of the third aspect as the terminal device.

According to the terminal device, the center device, the optical communication network system and the upstream signal timing control method of the aspects described above, it is possible to separately specify bit rates of upstream signals and downstream signals without performing periodic bandwidth assignments, and it is possible to achieve both simplicity of processing for synchronization establishment and lower costs.

What is claimed is:

1. An upstream signal timing control method which controls a timing of an upstream optical signal, from a terminal device to a center device, to a timing that the center device intends, the upstream signal timing control method comprising:
transmitting, from the center device to the terminal device, optical clock pulses synchronized with the timing that the center device intends;
the terminal device controlling a delay of the optical clock pulses and returning the optical clock pulses to the center device;
the center device detecting an offset between the timing and a timing of the returned optical clock pulses, and including information of the timing offset in the optical clock pulses that are being sent, and the terminal device performing the delay control in accordance with the information of the timing offset that has been included in the optical clock pulses that are received by the terminal device; and
the center device verifying completion of timing control of the upstream optical signal, when the offset between the timing and the timing of the returned optical clock pulses is less than a threshold value.

2. The upstream signal timing control method of claim 1, wherein
the center device accommodates a plurality of terminal devices;
the center device transmits the optical clock pulses with a phase corresponding to a single control terminal device of the plurality of terminal devices, with a timing which is synchronized with a downstream optical signal from the center device to all or a subset of the plurality of terminal devices, and with a wavelength which differs from a wavelength of the downstream optical signal; and wherein
each of the plurality of terminal devices extracts clock pulses relating thereto from the downstream optical signal, and identifies whether or not a particular terminal device is the control terminal device on the basis of a match or mismatch between timings of the extracted clock pulses and the optical clock pulses arriving from the center device.

3. The upstream signal timing control method of claim 2, wherein the center device sequentially changes the control terminal device and implements timing control of upstream optical signals for all of the plurality of terminal devices.

4. The upstream signal timing control method of claim 1, wherein the center device wavelength-multiplexes a downstream optical signal with a carrier wave for the upstream optical signal and transmits the same, and the terminal device, for which timing control has been completed, wavelength-demultiplexes and obtains the carrier wave for the upstream optical signal, and then superimposes on the carrier wave an upstream signal including a delay determined by the delay control and transmits the same to the center device as the upstream optical signal.

5. A center device of an optical communication network system in which at least one terminal device is accommodated at the center device, the at least one terminal device and the center device forming a passive optical network, and the center device comprising:
an optical clock pulse generation and transmission unit that generates and transmits optical clock pulses to a terminal device that is a current control terminal device, the optical clock pulses being synchronized with a timing of an upstream optical signal from the control terminal device to the center device;
a timing comparison unit that detects an offset between the timing and a timing of the optical clock pulses that have been delay-controlled and returned from the control terminal device;
a timing offset information addition unit that, when the detected timing offset is larger than a threshold value, adds information of the timing offset to the optical clock pulses and transmits the same to the control terminal device; and
a timing control completion verification unit that verifies completion of timing control of the upstream optical signal for the control terminal device when the detected timing offset is less than the threshold value.

6. A terminal device of an optical communication network system in which at least one of the terminal device is accommodated at a center device, the terminal device and the center device forming a passive optical network, and the terminal device comprising:
an optical clock pulse returning unit that returns optical clock pulses which have arrived from the center device; and
a delay unit that delays the optical clock pulses to be returned in accordance with timing offset information which has been applied to the optical clock pulses arriving from the center device.

7. An optical communication network system in which at least one terminal device is accommodated at a center device, the at least one terminal device and the center device forming a passive optical network, and the optical communication network system comprising
the center device, which comprises:
an optical clock pulse generation and transmission unit that generates and transmits optical clock pulses to a terminal device that is a current control terminal device, the optical clock pulses being synchronized with a timing of an upstream optical signal from the control terminal device to the center device;
a timing comparison unit that detects an offset between the timing and a timing of the optical clock pulses that have been delay-controlled and returned from the control terminal device;
a timing offset information addition unit that, when the detected timing offset is larger than a threshold value, adds information of the timing offset to the optical clock pulses and transmits the same to the control terminal device; and
a timing control completion verification unit that verifies completion of timing control of the upstream optical signal for the control terminal device when the detected timing offset is less than the threshold value, and
the at least one terminal device, which comprises:
an optical clock pulse returning unit that returns the optical clock pulses which have arrived from the center device; and
a delay unit that delays the optical clock pulses to be returned in accordance with the timing offset information that has been added to the optical clock pulses arriving from the center device.
